(19) United States
(12) Patent Application Publication
(10) Pub. No.: US 2025/0342491 A1
(43) Pub. Date: Nov. 6, 2025

(54) SMART MOBILITY AS A SERVICE PLATFORM

(71) Applicant: Conduent Business Services, LLC, Florham Park, NJ (US)

(72) Inventors: Sonia Bourdelin, Chabrillan (FR); Thomas Roux, Livron sur Drôme (FR)

(21) Appl. No.: 18/653,935

(22) Filed: May 2, 2024

(51) Int. Cl. G06Q 30/0201; G06Q 10/02; H04L 67/306

(52) U.S. Cl. CPC G06Q 30/0206; G06Q 10/025; H04L 67/306

(57) ABSTRACT

Methods and systems for implementing a tariff within a Mobility as a Service (MaaS) platform, can involve assembling a plurality of factors for tariff determination, the plurality of factors comprising tariff data that is true, reliable, optimized, and performative; invoking an algorithm of choice embedded within the MaaS platform to process the plurality of factors; and generating a tailored tariff for a user based on the processed plurality of factors by the algorithm of choice embedded within the MaaS platform, wherein the tailored tariff is customized to suit the individual needs and usage patterns of the user within the MaaS platform.

### TECHNICAL FIELD

Embodiments are related to the field of transportation and mobility. Embodiments further relate to Mobility as a Service (MaaS). Embodiments further relate to the integration of various forms of transportation services into a single, unified platform accessible on-demand.

### BACKGROUND

Mobility as a Service (MaaS) represents a paradigm shift in the way we perceive and utilize transportation. At its core, MaaS integrates various forms of transportation services into a single, accessible platform, offering users a seamless, secure and convenient way to get relevant information, plan, book, and pay for their journeys before, during and after the travel. This concept has emerged as a response to the evolving needs of urban populations, driven by factors such as population growth, congestion, environmental concerns, and advancements in technology.

Historically, transportation systems have been fragmented, with different modes of transport operating independently, leading to inefficiencies and complexities for users. For instance, individuals may need to use multiple apps or services to plan and pay for different legs of their journey, such as combining a bus ride with a subway trip or a bike rental.

The concept of MaaS originated from the realization that by integrating various modes of transportation into a unified platform, we can streamline the travel experience, reduce congestion, improve air quality, and enhance overall mobility. This integration is made possible through digital technologies, including smartphones, GPS, data analytics, and payment systems.

MaaS platforms typically offer users a range of transportation options, including public transit, ride-hailing services, bike-sharing, car-sharing, and even micromobility solutions like scooters. Users can access these services through a single app or platform, where they can plan their journeys, compare different options based on factors like cost and travel time, book tickets or reservations, and pay for their trips electronically.

One of the key advantages of MaaS is its potential to render transportation more affordable and accessible. By providing users with a comprehensive view of available transportation options, MaaS platforms empower users to make informed decisions, which in turn facilitate optimization of costs. For example, users may select between taking a bus, using a ride-hailing service, or renting a bike, based on factors such as distance, time constraints, and budget (but not limited to: weather, quantity of CO2, energy consumed, etc.).

Moreover, MaaS has the potential to introduce innovative pricing models, such as MaaS platform offers, subscription-based services or pay-as-you-go plans, which can offer greater flexibility and cost savings compared to traditional transportation fare structures. By leveraging data and analytics, MaaS providers can also offer personalized recommendations and incentives to encourage more sustainable and efficient travel behavior.

Mobility as a Service represents a transformative approach to transportation, offering users greater flexibility, convenience, and affordability while also contributing to broader societal goals such as reducing congestion and emissions. As urban populations continue to grow and evolve, MaaS is poised to play an increasingly important role in shaping the future of mobility.

Conventional MaaS platforms face a significant challenge in managing shared fare offers across multiple operators. This complexity arises from the necessity to negotiate and sign numerous agreements for each fare offer, involving various stakeholders. Consequently, the process becomes cumbersome and time-consuming. As a result, many agreements are left unsigned, leading to fragmented fare offers existing in isolation within the platform.

Moreover, the conventional approach of delegating fare calculations to individual mobility services proves inefficient in addressing this issue. The sheer volume of calculations required hampers performance, exacerbating the problem rather than resolving it. This limitation impedes the platform's ability to provide seamless and comprehensive fare solutions across diverse mobility options.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the embodiments to provide for improved methods, systems, and devices for a Mobility as a Service (MaaS) platform.

It also an aspect of the methods to provide for an improved method and system for the integration of various forms of transportation services into a single, unified platform accessible on-demand.

It is another aspect of the embodiments to provide for methods and systems for implementing a tariff within a MaaS platform.

It is a further aspect of the embodiments to provide for a true, reliable and optimized price for a complete trip in a complex and evolving context, along with a performance that allows for a quick response time.

The aforementioned aspects and other objectives and advantages can now be achieved as described herein. In an embodiment, a computer-implemented method of implementing a tariff within a Mobility as a Service (MaaS) platform, can involve: assembling a plurality of factors for tariff determination, the plurality of factors comprising tariff data that is true, reliable, optimized, and performative; invoking an algorithm of choice embedded within the MaaS platform to process the plurality of factors; and generating a tailored tariff for a user based on the processed plurality of factors by the algorithm of choice embedded within the MaaS platform, wherein the tailored tariff is customized to suit the individual needs and usage patterns of the user within the MaaS platform.

An embodiment can further involve offering the tailored tariff to the user through the MaaS platform after the tailored tariff is created based on the plurality of factors processed by the algorithm of choice.

In an embodiment, the tariff data that is true can include data related to the user including a user profile associated with the user.

In an embodiment, the tariff data that is reliable can include data comprising at least one of: a travel availability of the tariff, real-time travel conditions, and available seating.

In an embodiment, the tariff data that is optimized can comprise data based on a best tariff price determined by a central tariff computation of at least one of: local fares, combined fares, marketing offers, regional discount offers, national discount offers.

In an embodiment, the tariff data that is performative can comprise data processible through the MaaS platform, wherein the MaaS platform comprises an autonomous platform.

In an embodiment, the MaaS platform can comprise a modular architecture including a central component comprising a mobility provider.

In an embodiment, the MaaS platform includes a plurality of interfaces for data declaration.

In an embodiment, a system for implementing a tariff within a Mobility as a Service (MaaS) platform, can include: at least one processor; and a non-transitory computer-usable medium embodying computer program code, the computer-usable medium operable to communicate with the at least one processor, the computer program code comprising instructions executable by the at least one processor and operable for: assembling a plurality of factors for tariff determination, the plurality of factors comprising tariff data that is true, reliable, optimized, and performative; invoking an algorithm of choice embedded within the MaaS platform to process the plurality of factors; and generating a tailored tariff for a user based on the processed plurality of factors by the algorithm of choice embedded within the MaaS platform, wherein the tailored tariff is customized to suit the individual needs and usage patterns of the user within the MaaS platform.

In an embodiment, the instructions can be further configured for offering the tailored tariff to the user through the MaaS platform after the tailored tariff is created based on the plurality of factors processed by the algorithm of choice.

In an embodiment, a Mobility as a Service (MaaS) platform, can include: a modular architecture including a central component comprising a mobility provider, wherein the MaaS platform includes a plurality of interfaces for data declaration; wherein a plurality of factors can be assembled for tariff determination, the plurality of factors comprising tariff data that is true, reliable, optimized, and performative; wherein an algorithm of choice embedded within the MaaS platform can be invokable to process the plurality of factors; and wherein a tailored tariff for a user can be generated based on the processed plurality of factors by the algorithm of choice embedded within the MaaS platform, wherein the tailored tariff is customized to suit the individual needs and usage patterns of the user within the MaaS platform.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the embodiments.

FIG. 1 illustrates a block diagram of the architecture of a smart Mobility as a Service (MaaS) platform, which can be implemented in accordance with an embodiment;

FIG. 2 illustrates a flow-chart of operations depicting logical operational steps of a method for implementing a tariff within the Smart MaaS Platform, in accordance with an embodiment;

FIG. 3 illustrates a block diagram depicting attributes of the tariff resulting from the operations depicted FIG. 2, in accordance with an embodiment;

FIG. 4 illustrates a block diagram of a mobility transportation system that can incorporate the Smart MaaS Platform, in accordance with an embodiment;

FIG. 5 including FIG. 5 (Continued) illustrates a flow chart of operations depicting logical operation steps of a method for calculating a tariff, in accordance with an embodiment; and

FIG. 6 illustrates a block diagram of an example of a machine upon which one or more embodiments may be implemented.

Like reference numerals utilized herein can refer to identical or similar parts or elements.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

After reading this description it will become apparent how to implement the embodiments described in various alternative implementations. Further, although various embodiments are described herein, it is understood that these embodiments are presented by way of example only, and not limitation. As such, this detailed description of various alternative embodiments should not be construed to limit the scope or breadth of the appended claims.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. In addition, terms or phrases such as “at least one” may refer to “one or more”. For example, “at least one widget” may refer to “one or more widgets”.

Several aspects of data-processing systems are presented herein with reference to various systems and methods. These systems and methods are described in the following detailed description and illustrated in the accompanying drawings by various blocks, modules, components, circuits, steps, processes, algorithms, etc. (collectively can be referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

The embodiments relate to a computer-implemented method for establishing a tariff within a Mobility as a Service (MaaS) platform. Embodiments can involve assembling a comprehensive set of factors essential for tariff determination, including tariff data that is true, reliable, optimized, and performative. Subsequently, an algorithm of choice embedded within the MaaS platform can be invoked to process these factors and generate a tailored tariff for individual users based on the processed data. The embodiments aim to enhance the user experience and optimize pricing strategies within MaaS platforms, thereby fostering efficient and equitable mobility solutions.

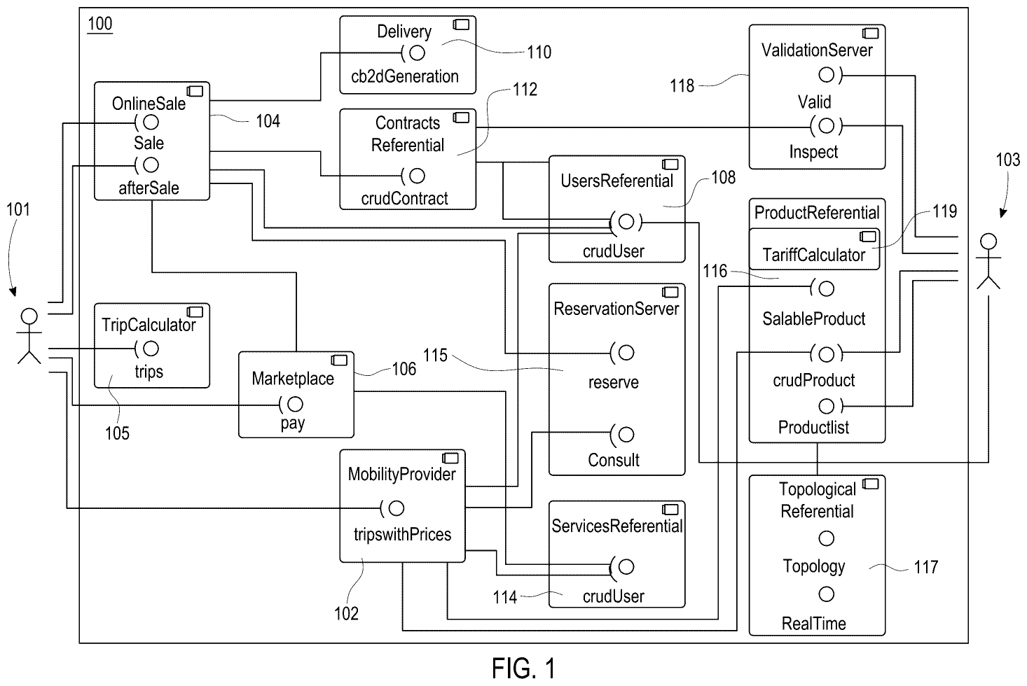

FIG. 1 illustrates a block diagram of the architecture of a smart Mobility as a Service (MaaS) platform 100, which can be implemented in accordance with an embodiment. Note that the term “smart” as utilized herein in the context of “Smart MaaS,” can relate to the integration of advanced technologies and data-driven decision-making processes within the MaaS platform. A “Smart MaaS” system can leverage various intelligent features such as artificial intelligence, machine learning, data analytics, and IoT (Internet of Things) devices to optimize transportation services, improve user experience, and enhance overall efficiency and sustainability of urban mobility. The term “platform” as utilized herein can relate to an online platform comprising a digital infrastructure or framework that facilitates interactions, transactions, or services between multiple users or parties.

The Smart MaaS platform 100 shown in FIG. 1 can include a number of components including modules such as a mobility provider 102 that can interact with a user 101 shown at the left side of the drawing and other modules such as, for example, a services referential module 114, a reservation server 115, users referential module 108, and a product referential module 116. The Smart MaaS platform 100 possesses a modular architecture with a central component comprising the mobility provider 102, which can enable efficient management and delivery of transportation/travel services and products through the Smart MaaS platform 100.

The Smart MaaS platform 100 further includes an online sale module 104 and a trip calculator 105. The user 101 can interact with the trip calculator 105, a marketplace module 106, the online sale module 104, and the mobility provider 102. The Smart MaaS platform 100 can also include a delivery module 110 and a contracts referential module 112. The online sale module 104 can interact and engage with the delivery module 110, the contracts referential module 112, the users referential module 108, the reservation server 115, and optionally, the marketplace module 106. The reservation server 115 includes two features, a “reserve” component and a “consult” component. The online sale module 104 can interact with the reserve component and the mobility provider 102 can interact with the consult component.

Note that the aforementioned “reserve” component and “consult” component of the reservation server 115 can play crucial roles in the functionality and effectiveness of the Smart MaaS platform 100. Here's why they are important: The “reserve” component of the reservation server 115 can be configured to handle booking process within the platform, and also facilitate the reservation of travel services, such as booking tickets for transportation, accommodations, or other related services. This component can ensure that user 101 can easily and efficiently make reservations for his or her travel needs, contributing to a seamless user experience. By managing the reservation process, the platform can coordinate various aspects of the user's journey, including scheduling, availability, and payment, streamlining the overall travel experience.

The “consult” component of the reservation server 115 can provide consultation and decision support functionalities to the mobility provider 102. It can assist the mobility provider 102 in making informed decisions regarding travel arrangements, pricing strategies, and service offerings based on real-time data and user preferences. The consult component can help optimize the allocation of resources, improve service quality, and enhance customer satisfaction by providing personalized and tailored recommendations.

By integrating the “reserve” and “consult” components, the reservation server 115 can enhance the efficiency and accuracy of the reservation process. Users can quickly find and book relevant travel services, while the mobility provider can leverage data-driven insights to optimize service delivery and pricing. This integration ensures that reservations are made promptly and accurately, minimizing errors and maximizing user satisfaction.

The reservation server's components can be designed to be scalable and adaptable to accommodate varying levels of demand and changing market conditions. As the platform grows and evolves, the reservation server can scale its capacity to handle increased transaction volumes while adapting its algorithms and decision-making processes to meet evolving user needs and preferences.

By handling reservation management functions, the reservation server 115 can streamline administrative processes and facilitates centralized oversight and control. This approach can allow for easier monitoring, auditing, and optimization of reservation activities, ensuring consistency and compliance with platform policies and regulations.

The Smart MaaS platform 100 also can include a validation server 118 that can communicate and interact with the contracts referential module 112 and a service 103, which represents the server side of the Smart MaaS platform 100. The server side is generally shown at the right hand side of the configuration shown in FIG. 1 and the user side, as represented by user 101, is indicated at the left hand side of the arrangement depicted in FIG. 1. The Smart MaaS platform 100 can further include a topological referential module 117 that communicates and engages with the product referential module 116. The service 103 can interact and communicate with the validation server 118, the product referential module 116 and the topological referential module 117.

The validation server 118 can validate and/or inspect the service 103 as indicated by the “valid” and “inspect” features shown as part of the validation server 118. The products referential module 116 can include a tariff calculator 119 (e.g., a tariff calculator module) with respect to product referential data such as data indicative of a “Salable Product,” a “CrudProduct,” and a “Product List.” The topological referential module 117 performs topology and real-time data applications for the product referential module 119.

As an example of how aspects of the Smart MaaS platform 100 may be implemented, information associated with the user 101 can be processed by the trip calculator 103 resulting in, for example, a travel sheet and fare propositions. The online sale module 104 can implement “sale” and “after sale” interactions with respect to the user 101. A booking process can be facilitated and completed through the reservation server 115. The marketplace module 106 can manage payments The online sale module 101 can interact with the delivery module 110 and the contracts referential module 112 to, for example, manage distribution of travel documents and other machine readable media. The contracts referential module 112 can manage contracts while supporting the validation server 118.

The Smart MaaS platform 100 can be designed to have some limited responsibilities for each component. The configuration of Smart MaaS platform 100 can be arranged to limit the adhesions between components. This weak coupling gives rise to high scalability for the Smart MaaS platform 100. Some of the components of the Smart MaaS platform 100 may be implemented in the context of a “public” API include user side, service side, and both user side and service side. In some embodiments, the user side of the Smart MaaS platform 100 may include, for example, the mobility provider 102, which can provide most or all travel solutions for the user 101. The user side can also include sales features for the user 101 to access, which can be facilitated by the online sale module 104. The marketplace module 106 may also be implemented as part of the user side of the Smart MaaS platform 100 in some embodiments to manage payments on behalf of the user as a unique payment.

On the service side (associated with service 103) of the Smart MaaS platform 100, the validation server 118 can be used to validate and inspect, for example, a transport ticket or all other form of travel document. Also on the service side, the products referential module 116 may be used to declare salable products. For both the service side and the user side, the user referential module 108 can manage one or more accounts associated with the user 101 in one unified account whatever the number of services the user has subscribed. The contracts referential module 112 can manage sold contracts and all media (i.e., the media can be a way to access contracts). The Smart MaaS platform 100 also includes internal components such as the services referential module 114 to manage service(s) 103. In some embodiments, the delivery module 110 can generate CB2D intercode and/or other travel documents.

Note that CB2D intercode refers to a type of code that can be used within the context of transportation and mobility services, particularly in the domain of MaaS platforms. CB2D stands for “Code Barcode 2D,” indicating a two-dimensional barcode format commonly used for encoding various types of information, such as ticket data, service details, or transaction identifiers. These barcodes can be typically scanned or read by mobile devices or dedicated scanners to facilitate transactions, validations, or access control within transportation systems.

The “intercode” aspect denotes that these barcodes may serve as an intermediate or interface code, enabling communication or interoperability between different components or systems associated with the MaaS platform such as ticketing systems. This can include exchanging information between users, service providers, payment systems, equipment or other entities involved in the transportation ecosystem. The interfaces are mostly based on norms (Product definition in NeTex by example) or standards.

The Smart MaaS platform 100 thus includes various modules and components, each playing a crucial role in delivering efficient transportation services and enhancing user experience. At the forefront, the mobility provider 102, associated with the trip calculator 106 and the users referential module 108, along with other modules, can serve as the central entity interacting with the user 101, offering a wide array of travel solutions. Facilitating user engagement and access to services are modules like the user referential module 108 and the validation server 118.

Furthermore, the Smart MaaS platform 100 incorporates modules such as the services referential module 114 and the products referential module 116, which enable the management and provision of diverse services and products within the ecosystem. The online sale module 101 facilitates seamless transactions, encompassing both sale and after-sale interactions, thereby ensuring a smooth user experience.

Integral to the functionality of the Smart MaaS platform 100 is the marketplace module 106, responsible for managing payments and transactions. Its inclusion underscores the platform's commitment to convenience and accessibility for users engaging with various mobility services.

The platform's architecture emphasizes a distributed and loosely coupled design, with limited dependencies between components. This design philosophy fosters scalability, enabling the platform to accommodate evolving needs and scale seamlessly with growing demand. Leveraging a “public” API framework, components are organized into user-side and service-side categories, streamlining interactions and enhancing flexibility.

On the service side, the validation server 118 can serve a critical role in validating and inspecting transport tickets, ensuring compliance and integrity within the system. Additionally, modules like the products referential module 116 facilitate the declaration of salable products, including his own, enhancing the platform's versatility and market offerings.

Both user-side and service-side functionalities are supported by modules such as the user referential module 108, responsible for managing user accounts, and the contracts referential module 112, overseeing sold contracts. Internal components like the services referential module 114 and the delivery module 110 can further contribute to the platform's robust infrastructure, enabling efficient management of services and generating CB2D intercode (or other any normalized/standardized travel document) for enhanced communication capabilities.

In essence, the Smart MaaS platform 100 embodies a sophisticated ecosystem powered by advanced technologies and modular architecture, poised to revolutionize urban mobility by offering seamless, efficient, and personalized transportation solutions to users worldwide.

The “Smart MaaS” platform 100 may incorporate features such as real-time route optimization, predictive maintenance for vehicles, dynamic pricing based on demand and supply, personalized travel recommendations, seamless integration with multiple transportation modes (e.g., public transit, ridesharing, biking, walking), and proactive management of traffic congestion and environmental impact. The term “smart” emphasizes the platform's ability to adapt, learn, and evolve based on real-time data and user interactions, ultimately leading to more efficient, convenient, and sustainable transportation solutions.

Important among the many various intelligent features of the Smart MaaS platform 100 is the use of an algorithm of choice. An “algorithm of choice” for use in the Smart MaaS platform 100 can relate to a computational method or procedure selected based on its suitability for processing various factors essential for tariff determination within the platform. This algorithm can be selected for its ability to effectively analyze and interpret data related to user preferences, travel patterns, demand forecasting, pricing models, and other relevant variables. The selection process involves considering factors such as accuracy, efficiency, scalability, and adaptability to the dynamic nature of the MaaS environment.

A number of characteristics can be configured for such one or more algorithm of choice for particular metrics like best price or energy consumption. For example, the algorithm should be proficient in handling large volumes of data from diverse sources, including real-time data streams, historical data, and user-generated data. In addition, the algorithm should possess predictive modeling capabilities to forecast demand patterns, optimize resource allocation, and anticipate user behavior to inform tariff adjustments. In case of a pricing calculation, the algorithm can also incorporate optimization methods to maximize efficiency and cost-effectiveness in tariff determination, considering factors such as route optimization, pricing optimization, and resource utilization. Also, utilization of machine learning and artificial intelligence techniques can enable the algorithm to continuously learn from user interactions and feedback, improving its ability to generate personalized tariffs and adapt to changing market conditions.

The algorithm can also be scalable to accommodate the growing user base and increasing complexity of MaaS operations while maintaining high performance and responsiveness. The algorithm can also allow for customization and flexibility to accommodate diverse user preferences, regulatory requirements, and business objectives of the MaaS platform operator. By employing an algorithm of choice tailored to the specific needs and objectives of the Smart MaaS platform 100, operators can optimize tariff determination processes, enhance user satisfaction, and promote the adoption of sustainable and efficient mobility solutions.

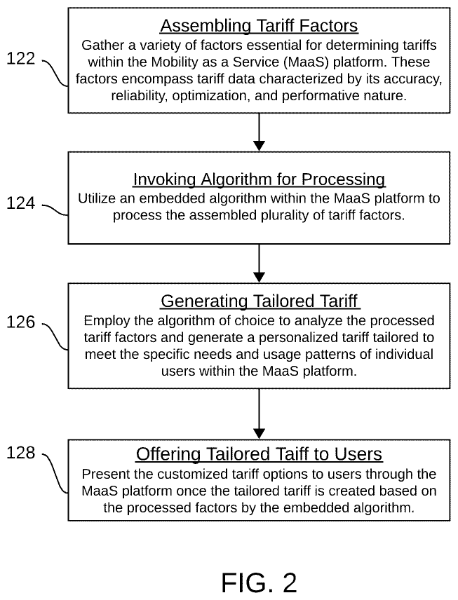

FIG. 2 illustrates a flow-chart of operations depicting logical operational steps of a method 120 for implementing a tariff within the Smart MaaS Platform 100, in accordance with an embodiment. As shown at block 122, a step or operation can be implemented for assembling tariff factors. The step or operation depicted at block 122 can involve gathering variety of factors essential for determining tariffs within the Smart MaaS Platform 100. These factors can encompass user data (e.g., choices, commercial profile, etc.), context data (e.g., traffic perturbation, weather, etc.) and tariff data (e.g., fare tables) that can be characterized by its accuracy, reliability, optimization, and performative nature. Next, as indicated at block 124, a step or operation can be implemented to invoke a particular algorithm (e.g., algorithm of choice) for processing. The step or operation depicted at block 124 can involve utilizing an embedded (i.e., algorithm of choice) within the Smart MaaS Platform 100 to process the assembled tariff factors.

As shown at block 126, a step or operation can be implemented to generate the tailored tariff. The step or operation shown at block 126 can involve employing the algorithm of choice to analyze the processed tariff factors and generate a personalized tariff tailored to meet the specific needs and usage patterns of individual users within the Smart MaaS Platform 100 (strategies of module 102). As illustrated next at block 128, a step or operation can be implemented to offer the tailored tariff to the user (e.g., user 101 in FIG. 1). The step or operation indicated at block 128 can involve presenting the customized tariff options to users through the Smart MaaS Platform 100 once the tailored tariff is created based on the processed factors by the embedded algorithm. The presentation of the tailored tariff to the user 101 can occur through a graphical user interface or other user interface accessible the user via the Smart MaaS Platform 100 and the module 102. Note that the Smart MaaS Platform 100 can offer multiple interfaces for data declaration, which can facilitate data declaration and interaction, and enhance flexibility and usability for users such as user 101.

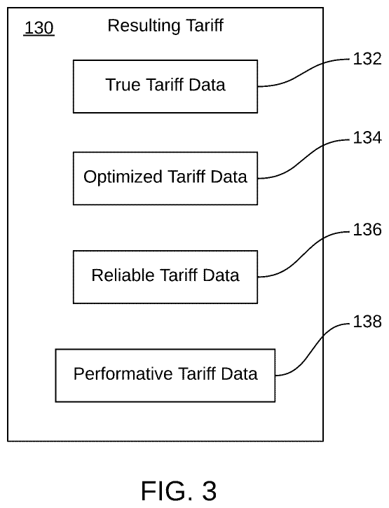

FIG. 3 illustrates a block diagram depicting attributes of the tariff 130 resulting from the operations depicted in method 120 of FIG. 2, in accordance with an embodiment. The tariff 130 is processed and generated with the inclusion of true tariff data 132 including, for example, user-related information such as user profiles associated with respective users. The tariff 130 is thus true whereas some other platforms may provide approximated data. The true tariff considers every data impacting in one way the tariff: the user profile, his or her age, his or her preferences for walking or biking, stages, disabilities, etc. As discussed previously, the Smart MaaS Platform 100 has a modular architecture built with a central component: the mobility provider module 102. Each module is used following mobility provider's strategies. Moreover, some processes and methods guarantee that the products, fares, and tariffs data are of quality, up to date, exhaustive and persistent.

The tariff 130 is also generated based on the optimization of tariff data. That is optimized tariff data 124 is produced by determining, for example, the best tariff price through central tariff computation, considering factors such as local fares, combined fares, marketing offers, regional discount offers, and national discount offers. The price is thus much more optimized than on other platforms, which usually request each carriers their price of one leg according to a limited context (e.g., leg and fares of the carrier). The Smart MaaS Platform 100, on the other hand, knows all the fares. This includes local fares, combined fares, marketing offers, regional or national discount offers, etc. Natively, the Smart MaaS Platform 100 can implement strategies to find this best price in a central tariff computation.

The tariff 130 is also configured based on the reliability of tariff data. That is, reliable tariff data can incorporate reliable data sources, encompassing aspects such as, for example, travel availability, real-time travel conditions, and available seating. The disclosed embodiments thus offer a reliable tariff because it checks the travel availability at this tariff. On other platforms, the product is sold even if it cannot be used (based on statistics or other forecasts). The Smart MaaS Platform 100 can, by example, check in real-time the travel conditions or the available seats and rephrasing the query if needed.

The tariff 130 can also be generated based on the performative nature of the tariff data. That is, performative tariff data 138 for involve data that ensures that tariff data is performative and processible within the Smart MaaS Platform 100 (time user answer), which may include autonomous platform capabilities.

The Smart MaaS Platform 100 is more performant than conventional platforms because such conventional approaches dynamically utilize third parties to delegate the calculations. Consequently, their answers are very slow and depend on service availability. The Smart MaaS Platform 100 can outperform conventional platforms due to its unique design. Unlike conventional methods that rely on third-party services for calculations, the Smart MaaS Platform 100 can handle all computations internally. This means its responses are faster and not dependent on the availability of external services.

Moreover, the Smart MaaS Platform 100 operates autonomously, meaning it has access to all the necessary data required for computations without relying on external sources. This ensures efficiency and reliability since the platform has all the data it needs readily available.

Additionally, the platform offers various interfaces like MMI (Man-Machine Interface) and APIs (Application Programming Interfaces) for easy data declaration, such as fare products and tariffs. With comprehensive and well-organized local data (e.g., data version management by example), the platform guarantees quick and consistent performance, making it a superior choice compared to traditional approaches.

The Smart MaaS Platform 100 introduces a significant innovation by offering accurate, reliable, and optimized pricing for complete trips in complex and evolving transportation scenarios. This innovation ensures not only accuracy but also quick response times, setting it apart from other platforms. The platform excels in four key areas: providing true, reliable, optimized, and quickly accessible tariffs, a feat that other platforms struggle to achieve simultaneously. The true tariffs consider a multitude of factors such as user profiles, age, transportation preferences, stages of the trip, and any disabilities, ensuring a comprehensive and precise pricing structure.

Built on a modular architecture with a central component known as the mobility provider, the platform adapts to various strategies employed by different providers. Processes and methods are in place to maintain high-quality, up-to-date, exhaustive, and consistent data on products, fares, and tariffs.

One of the key benefits of the Smart MaaS Platform is its ability to offer reliable tariffs by verifying travel availability at the quoted price. In contrast, other platforms may sell products even if they cannot be utilized, relying on statistical or forecast-based models. The platform can dynamically check real-time travel conditions and available seats and options, adjusting queries as necessary.

Furthermore, pricing on the Smart MaaS Platform is highly optimized compared to other platforms. While traditional platforms typically request pricing information from carriers for individual legs of a journey within a limited context, Smart MaaS has access to a comprehensive database of fares, including local, combined, marketing offers, and regional or national discounts. Its centralized tariff computation employs sophisticated strategies to find the best prices.

In terms of performance, the Smart MaaS Platform 100 outshines its competitors by eliminating the need to dynamically call third-party services for calculations. This reliance on external services often leads to slow response times and dependency on service availability. Being an autonomous platform, Smart MaaS requires all necessary data for computations to be provided internally. It offers interfaces such as MMI and APIs for easy data declaration, ensuring that exhaustive and organized data are quickly accessible, resulting in superior performance.

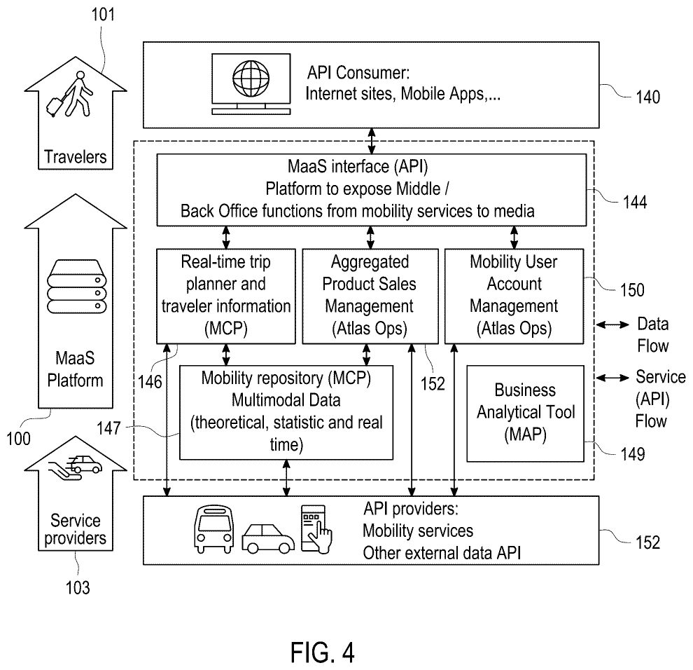

FIG. 4 illustrates a block diagram of a mobility transportation system 140, which can incorporate the Smart MaaS Platform 100, in accordance with an embodiment. The mobility transportation system 100 is one example of a transportation system that can benefit from the incorporation of the Smart MaaS Platform 100. The mobility transportation system 140 includes service providers 103 and travelers (users) 103. The mobility transportation system 140 further includes API consumer applications 142 (e.g., internet sites, mobile apps, etc.) in addition to a MaaS interface (API) 144 that can interact with a real-time trip planner and traveler information (MCP) module 146, an aggregated product sales management module 148, and a mobility user account management module 150. The real-time trip planner and traveler information (MCP) module 146 and the aggregated product sales management module 148 can interact and communicate with a mobility repository (MCP) 147 that stores multimodal data (theoretical, statistic, and real-time). The mobility transportation system 140 further includes a business analytical tool (MAP) 149. In addition, the mobility transportation system 140 includes API providers 152 such as, for example, mobility services, and other external data API.

The flow charts and block diagrams in the figures illustrate the architecture, functionality, and operation of possible implementations of systems, methods, and computer program products according to various embodiments (e.g., preferred or alternative embodiments). In this regard, each block in the flow chart or block diagrams depicted and described herein can represent a module, segment, or portion of instructions, which can comprise one or more executable instructions for implementing the specified logical function(s).

Note that in some alternative implementations, the functions noted in the blocks may occur out of the order noted in the figures. For example, two blocks shown in succession may, in fact, be executed concurrently, or the blocks may sometimes be executed in the reverse order, depending upon the functionality involved. It will also be noted that the blocks of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be typically private (accessible only to that module) and which includes source code that actually implements the routines in the module. The term module may also simply refer to an application, such as a computer program designed to assist in the performance of a specific task, such as word processing, accounting, inventory management, etc. In some example embodiments, the term “module” can also refer to a modular hardware component or a component that is a combination of hardware and software.

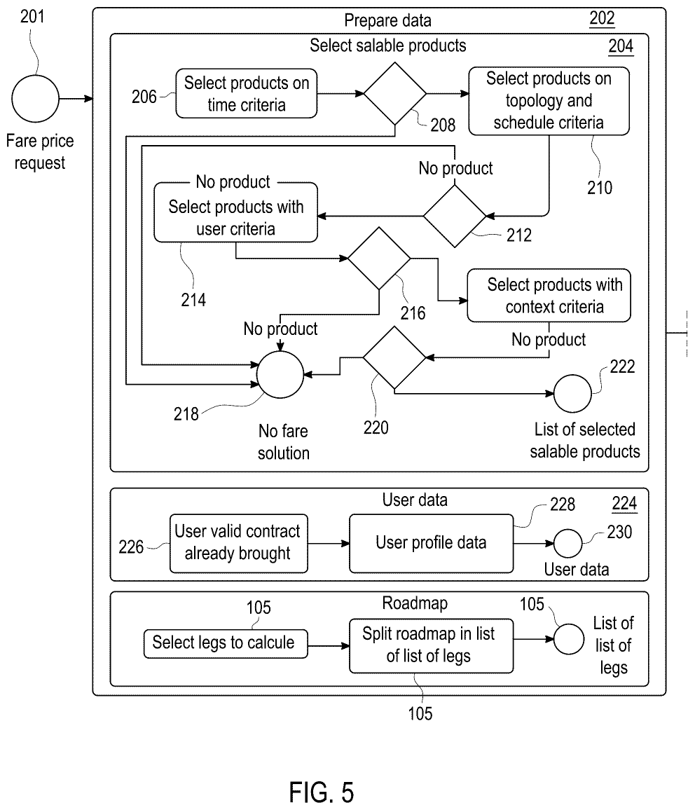

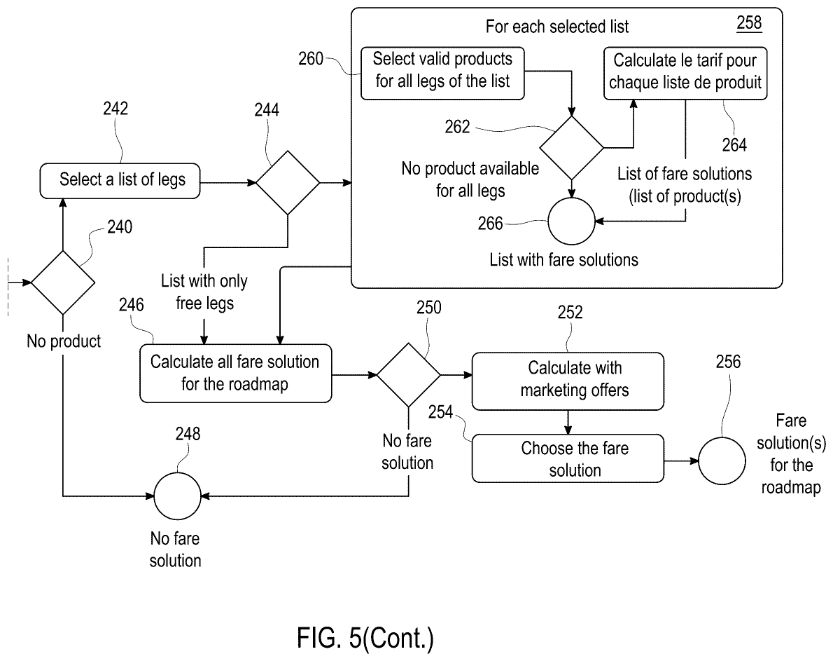

FIG. 5 illustrates a flow chart of operations depicting logical operation steps of a method 200 for calculating a tariff, in accordance with an embodiment. A fare price request 201 can be initiated and submitted for processing by operations 202 involving preparation of data. The operations 202 include operations 204 involving the selection of salable products, and operations 224 involving process of user data, along with operations 232 involving a roadmap for calculating one or more legs of a trip.

As shown at block 206, a step or operation can be implemented to select products based on time criteria. The result of the operation shown at block 206 can be subject to a decision operation as shown at block 208 resulting in the selection of products based on topology and schedule criteria or further processing as indicated at connector 218 in which no fare solution is determined. Following processing of the operation shown at block 210 another decision operation can be implemented as shown at decision block 212 to determine if there is no product or if there is no product, select products with user criteria as shown at block 214.

After processing of the operation shown at block 214, another decision operation may be implemented as indicated at block 216 followed by a “no product” determination or an operation as shown at block 213 to select products with context criteria. Following process of the operation shown at block 213 (with “no product” results), a decision operation can be implemented as shown at block 220 followed by the generation of a list of selected salable products as shown at connector 222. Note the circle of connector symbols shown in FIG. 5 can indicate a continuation of the logical flow of the method 200.

The user data operation 224 can include an operation to verify validation of a user contract purchased by a user (e.g., such as user 101 shown in FIG. 1) as shown at block 226, followed by an operation as indicated at block 228 to configure user profile data associated with the user 101. The user data can be then complied and ready for further storage and processing as shown at connector 232.

The roadmap operation 232 can include operations involving the selection of legs (e.g. trip legs) for further calculation as shown at block 234, followed by an operation to split the roadmap in a list of the lists of the legs, as indicated at block 236. Then, as shown at connector 238, the list of the list of legs is ready for further processing or actions.

Following completions of the operations/activities of the data preparation operations 202, a step or operation can be implemented as shown at decision block 240 to determine if “no product” is present or ready, or if a list of legs is selected, as shown at block 242. Assuming the answer is “no product” as shown at decision block 240, a “no fare solution” condition occurs as shown at connector 248. Assuming, however, that a product is present or ready, then the operation shown at block 242 is processed following by a decision operation, as indicated at decision block 244. As a result of the decision operation processed as shown at decision block 244, two paths are possible. The operations shown in block 258 can be implemented, or a list with only free legs may be subject to a calculation operation, as indicated at block 246 to calculate all fare solutions for the roadmap. Following processing of the operation shown at block 246, a decision operation can be implemented as shown at decision block 250 in which a ‘no fare solution’ may be determined or an operation to calculate with marketing offers, can be implemented, as shown at block 252. After processing of the operation depicted at block 252, an operation can be implemented to choose the fare solution as indicated at block 254, followed by generation of the fare solution(s) for the roadmap, as shown at block 256.

The operations shown at block 258 can be implemented for each selected list after implementation of the decision operation depicted at decision block 244. These operations can include a step or operation for selecting valid products for all legs of the list, as shown at block 260 followed by a decision operation as shown at block 262 to determine “no products available for all legs” or implementation of an operation to calculate the price for each product list as shown at block 264. Following processing of the operation indicated at block 264, the list of fare solutions (list of products) can be included with the list with fare solutions, as shown at block 266.

The method 200 provides for a number of advantages, such as allowing for the selection of salable products based on various criteria such as time, topology, schedule, user criteria, and context criteria. This flexibility ensures that the tariff calculation process can adapt to different user needs and preferences. In addition, by verifying the validation of a user contract purchased by the user, the method ensures that the tariff calculation process is aligned with the contractual agreements in place. This validation adds a layer of security and accuracy to the calculation process.

Furthermore, the method 200 can include an operation to configure user profile data associated with the user. By considering user profiles, the tariff calculation process can personalize tariffs based on individual user characteristics and preferences, enhancing user satisfaction and engagement. In addition, the operations involving the selection and splitting of trip legs can provide a structured approach to handling complex trip itineraries. By breaking down the roadmap into manageable segments, the method facilitates efficient calculation and optimization of tariffs for each leg of the trip.

The method 200 accommodates multiple paths for determining fare solutions, including considering free legs, marketing offers, and selecting valid products for all legs. This versatility ensures that the tariff calculation process can explore different options to find the most suitable fare solutions for users. The method 200 also includes operations to calculate fare solutions for each product list and consider various factors such as product availability and pricing. This comprehensive approach ensures that the tariff calculation process takes into account all relevant considerations to generate accurate and competitive fare solutions. The method 200 thus offers a robust and adaptable framework for calculating tariffs, providing users with personalized and optimized pricing options for their travel needs.

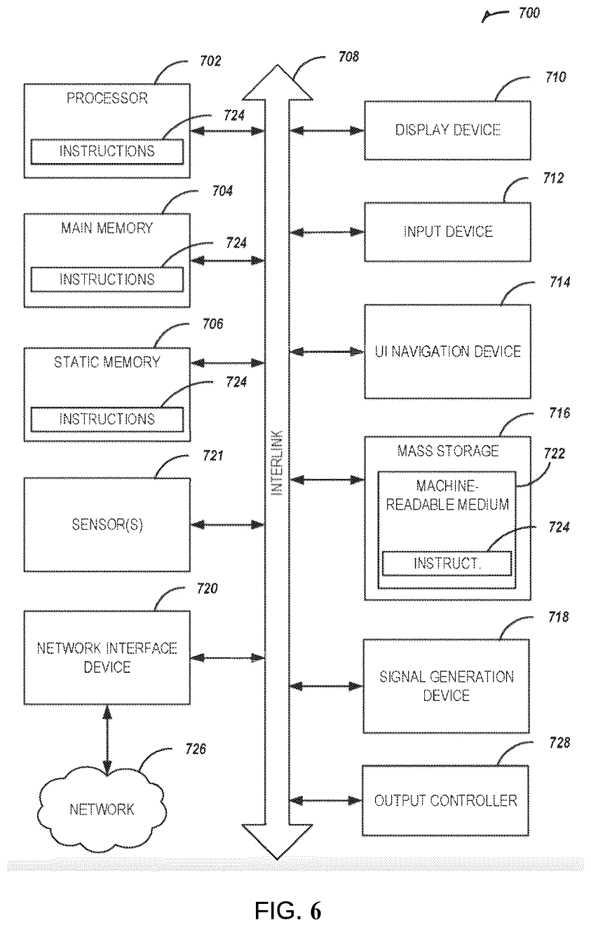

FIG. 6 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. For example, in some embodiments, the machine 700 can implement servers such as, for example, the validation server 118 and/or the reservation server 115 shown in FIG. 1

In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensors. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks). Plain Old Telephone (POTS) networks, and wireless data networks (e.g., Institute of Electrical and Electronics Engineers (IEEE) 802.11 family of standards known as Wi-Fi®, LoRa/LoRaWAN low power wide area network (LPWAN) standards, etc.). IEEE 802.15.4 family of standards, peer-to-peer (P2P) networks, satellite communication networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

Based on the foregoing, it can be appreciated that a number of embodiments including preferred and alternative embodiments are disclosed herein. For example, in an embodiment, a computer-implemented method of implementing a tariff within a Mobility as a Service (MaaS) platform, can involve assembling a plurality of factors for tariff determination, the plurality of factors comprising tariff data that is true, reliable, optimized, and performative; invoking an algorithm of choice embedded within the MaaS platform to process the plurality of factors; and generating a tailored tariff for a user based on the processed plurality of factors by the algorithm of choice embedded within the MaaS platform, wherein the tailored tariff is customized to suit the individual needs and usage patterns of the user within the MaaS platform.

An embodiment of the computer-implemented method can further involve offering the tailored tariff to the user through the MaaS platform after the tailored tariff is created based on the plurality of factors processed by the algorithm of choice.

In an embodiment of the computer-implemented method, tariff data that is true can include data related to the user including a user profile associated with the user.

In an embodiment of the computer-implemented method, the tariff data that is reliable can include data comprising one or more of, for example, a travel availability of the tariff, real-time travel conditions, and available seating.

In an embodiment of the computer-implemented method, the tariff data that is optimized can comprise data based on a best tariff price determined by a central tariff computation of one or more of: local fares, combined fares, marketing offers, regional discount offers, national discount offers

In an embodiment of the computer-implemented method, the tariff data that is performative can comprise data processible through the MaaS platform, wherein the MaaS platform includes an autonomous platform.

In an embodiment of the computer-implemented method, the MaaS platform can comprise a modular architecture including a central component comprising a mobility provider.

In an embodiment of the computer-implemented method, the MaaS platform can include a plurality of interfaces for data declaration.

In another embodiment, a system for implementing a tariff within a Mobility as a Service (MaaS) platform, can include at least one processor, and a non-transitory computer-usable medium embodying computer program code, the computer-usable medium operable to communicate with the at least one processor. The computer program code can include instructions executable by the at least one processor and operable for: assembling a plurality of factors for tariff determination, the plurality of factors comprising tariff data that is true, reliable, optimized, and performative; invoking an algorithm of choice embedded within the MaaS platform to process the plurality of factors; and generating a tailored tariff for a user based on the processed plurality of factors by the algorithm of choice embedded within the MaaS platform, wherein the tailored tariff is customized to suit the individual needs and usage patterns of the user within the MaaS platform.

In an embodiment of the system, the instructions can be further configured for offering the tailored tariff to the user through the MaaS platform after the tailored tariff is created based on the plurality of factors processed by the algorithm of choice.

In an embodiment of the system, the tariff data that is true can include data related to the user including a user profile associated with the user.

In an embodiment of the system, the tariff data that is reliable can include data comprising one or more of, for example, a travel availability of the tariff, real-time travel conditions, and available seating.

In an embodiment of the system, the tariff data that is optimized can comprise data based on a best tariff price determined by a central tariff computation of one or more of, for example, local fares, combined fares, marketing offers, regional discount offers, national discount offers.

In an embodiment of the system, the tariff data that is performative can comprise data processible through the MaaS platform, wherein the MaaS platform includes an autonomous platform.

In an embodiment of the system, the MaaS platform can comprise a modular architecture including a central component comprising a mobility provider.

In an embodiment of the system, the MaaS platform can include a plurality of interfaces for data declaration.

In another embodiment, a Mobility as a Service (MaaS) platform, can include: a modular architecture including a central component comprising a mobility provider, wherein the MaaS platform includes a plurality of interfaces for data declaration; wherein a plurality of factors is assembled for tariff determination, the plurality of factors comprising tariff data that is true, reliable, optimized, and performative; wherein an algorithm of choice embedded within the MaaS platform is invokable to process the plurality of factors; and wherein tailored tariff for a user is generated based on the processed plurality of factors by the algorithm of choice embedded within the MaaS platform, wherein the tailored tariff is customized to suit the individual needs and usage patterns of the user within the MaaS platform.

In an embodiment of the MaaS platform, the tariff data that is true can include data related to the user including a user profile associated with the user.

In an embodiment of the MaaS platform, the tariff data that is reliable can include data comprising one or more of, for example, a travel availability of the tariff, real-time travel conditions, and available seating.

In an embodiment of the MaaS platform, the tariff data that is optimized can comprise data based on a best tariff price determined by a central tariff computation of one or more of, for example: local fares, combined fares, marketing offers, regional discount offers, national discount offers.

In an embodiment of the MaaS platform, the tariff data that is performative can comprise data processible through the MaaS platform, wherein the MaaS platform comprises an autonomous platform.

In an embodiment of the MaaS platform, the tailored tariff can be offered to the user through the MaaS platform after the tailored tariff is created based on the plurality of factors processed by the algorithm of choice.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A computer-implemented method of implementing a tariff within a Mobility as a Service (MaaS) platform, comprising:
assembling a plurality of factors for tariff determination, the plurality of factors comprising tariff data that is true, reliable, optimized, and performative;
invoking an algorithm of choice embedded within the MaaS platform to process the plurality of factors; and
generating a tailored tariff for a user based on the processed plurality of factors by the algorithm of choice embedded within the MaaS platform, wherein the tailored tariff is customized to suit the individual needs and usage patterns of the user within the MaaS platform.

2. The computer-implemented method of claim 1 further comprising offering the tailored tariff to the user through the MaaS platform after the tailored tariff is created based on the plurality of factors processed by the algorithm of choice.

3. The computer-implemented method of claim 1 wherein the tariff data that is true includes data related to the user including a user profile associated with the user.

4. The computer-implemented method of claim 1 wherein the tariff data that is reliable includes data comprising at least one of: a travel availability of the tariff, real-time travel conditions, and available seating.

5. The computer-implemented method of claim 1 wherein the tariff data that is optimized comprises data based on a best tariff price determined by a central tariff computation of at least one of: local fares, combined fares, marketing offers, regional discount offers, national discount offers.

6. The computer-implemented method of claim 1 wherein the tariff data that is performative comprises data processible through the MaaS platform, wherein the MaaS platform comprises an autonomous platform.

7. The computer-implemented method of claim 1 wherein the MaaS platform comprises a modular architecture including a central component comprising a mobility provider.

8. The computer-implemented method of claim 1 wherein the MaaS platform includes a plurality of interfaces for data declaration.

9. A system for implementing a tariff within a Mobility as a Service (MaaS) platform, comprising:
at least one processor; and
a non-transitory computer-usable medium embodying computer program code, the computer-usable medium operable to communicate with the at least one processor, the computer program code comprising instructions executable by the at least one processor and operable for:
assembling a plurality of factors for tariff determination, the plurality of factors comprising tariff data that is true, reliable, optimized, and performative;
invoking an algorithm of choice embedded within the MaaS platform to process the plurality of factors; and
a tailored tariff for a user based on the processed plurality of factors by the algorithm of choice embedded within the MaaS platform, wherein the tailored tariff is customized to suit the individual needs and usage patterns of the user within the MaaS platform.

10. The system of claim 9 wherein the instructions are further configured for offering the tailored tariff to the user through the MaaS platform after the tailored tariff is created based on the plurality of factors processed by the algorithm of choice.

11. The system of claim 9 wherein the tariff data that is true includes data related to the user including a user profile associated with the user.

12. The system of claim 9 wherein the tariff data that is reliable includes data comprising at least one of: a travel availability of the tariff, real-time travel conditions, and available seating.

13. The system of claim 9 wherein the tariff data that is optimized comprises data based on a best tariff price determined by a central tariff computation of at least one of: local fares, combined fares, marketing offers, regional discount offers, national discount offers.

14. The system of claim 9 wherein the tariff data that is performative comprises data processible through the MaaS platform, wherein the MaaS platform comprises an autonomous platform.

15. The system of claim 9 wherein the MaaS platform comprises a modular architecture including a central component comprising a mobility provider.

16. The system of claim 9 wherein the MaaS platform includes a plurality of interfaces for data declaration.

17. A Mobility as a Service (MaaS) platform, comprising:
a modular architecture including a central component comprising a mobility provider, wherein the MaaS platform includes a plurality of interfaces for data declaration;
wherein a plurality of factors is assembled for tariff determination, the plurality of factors comprising tariff data that is true, reliable, optimized, and performative;
wherein an algorithm of choice embedded within the MaaS platform is invokable to process the plurality of factors; and
wherein a tailored tariff for a user is generated based on the processed plurality of factors by the algorithm of choice embedded within the MaaS platform, wherein the tailored tariff is customized to suit the individual needs and usage patterns of the user within the MaaS platform.

18. The MaaS Platform of claim 17 wherein:
the tariff data that is true includes data related to the user including a user profile associated with the user;
the tariff data that is reliable includes data comprising at least one of: a travel availability of the tariff, real-time travel conditions, and available seating;
the tariff data that is optimized comprises data based on a best tariff price determined by a central tariff computation of at least one of: local fares, combined fares, marketing offers, regional discount offers, national discount offers; and
wherein the tariff data that is performative comprises data processible through the MaaS platform, wherein the MaaS platform comprises an autonomous platform.

19. The MaaS Platform of claim 17 wherein the tailored tariff is offered to the user through the MaaS platform.

20. The MaaS Platform of claim 17 wherein the tailored tariff is offered to the user through the MaaS platform after the tailored tariff is created based on the plurality of factors processed by the algorithm of choice.
